(19) United States
(12) Patent Application Publication
(10) Pub. No.: US 2025/0079940 A1
(43) Pub. Date: Mar. 6, 2025

(54) ELECTRIC MACHINE WITH COOLING SYSTEM

(71) Applicant: DANA TM4 INC., Boucherville (CA)

(72) Inventors: Sabahattin DIZDAR, Montreal (CA); Luke MILLER, Montreal (CA)

(21) Appl. No.: 18/812,669

(22) Filed: Aug. 22, 2024

Related U.S. Application Data
(60) Provisional application No. 63/579,871, filed on Aug. 31, 2023.

(51) Int. Cl. H02K 9/19; H02K 7/00

(52) U.S. Cl. CPC H02K 9/19; H02K 7/003

(57) ABSTRACT

Systems and methods for an electric machine. In one example, the electric machine includes a rotor shaft with a central cavity, an oil inlet, and a tapered section profiled to direct oil away from the oil inlet and toward an oil outlet. The rotor shaft further includes an insert which is positioned in an outer rotor shaft section and configured to direct oil towards the oil outlet.

### CROSS REFERENCE TO RELATED APPLICATION

The present application claims priority to U.S. Provisional Application No. 63/579,871, entitled “ELECTRIC MACHINE WITH COOLING SYSTEM”, and filed on Aug. 31, 2023. The entire contents of the above-listed application are hereby incorporated by reference for all purposes.

### TECHNICAL FIELD

The present disclosure relates to an electric machine with a cooling system for a rotor shaft.

### BACKGROUND AND SUMMARY

Electric motors used in electric vehicles (EVs) and other applications have made attempts to cool the motor using closed channels which flow fluid therethrough to increase motor efficiency. However, the inventors have recognized that certain closed channel motor cooling arrangements may experience pressure losses due to air entrainment in the pressurized channels, thereby decreasing cooling performance and motor efficiency, more generally. Further, the inventors have recognized a desire to achieve a high level of motor cooling performance (e.g., particularly in a non-pressurized environment).

Facing the abovementioned issues, the inventors developed an electric machine to at least partially overcome the aforementioned issues. In one example, the electric machine includes a rotor shaft. The rotor shaft includes a central cavity, an oil inlet, a tapered section which is profiled to direct oil away from the oil inlet and toward an oil outlet, and an insert that is positioned within an outer rotor shaft section and configured to direct oil towards the oil outlet. In this way, the electric machine is effectively cooled, thereby increasing machine operating efficiency.

In one example, the outer rotor shaft section and the insert may be constructed out of different metals. For instance, the insert may be constructed out of aluminum and the outer rotor shaft section may be constructed out of steel. Using steel to construct the outer rotor shaft section allows the shaft to achieve a desired amount of strength and torque transfer. Further, using this material construction in the rotor shaft and specifically an aluminum insert, allows the weight of the shaft to be reduced and the thermal conductivity to be increased. In other examples, the insert may be constructed out of copper to further increase thermal conductivity. However, using a copper insert would increase the machine's weight when compared to an aluminum insert. Consequently, electric machine efficiency is further increased.

Further, in another example, the insert may include multiple grooves. The grooves may have a straight or spiral shape. Constructing the insert in this manner allow the insert to induce higher oil flow in an axial direction towards an outlet of the rotor shaft, further increasing rotor shaft cooling. Specifically, using spiral grooves may induce higher oil flow in the axial direction, further increasing cooling performance.

In another example, a mechanically bonded interface may be formed between an outer surface of the insert and an inner surface of the outer shaft section. Mechanical bonding the insert and the outer shaft section decreases the thermal resistance between the components, thereby increasing cooling performance. The mechanical bonding may be achieved via a thermally conductive adhesive, brazing of the surfaces, radially pushing the outer shaft section inwards when the insert is inside, and/or press-fitting, for instance.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of a vehicle that includes an electric machine.

FIG. 2 shows an example of a rotor shaft and cooling system for an electric machine.

FIGS. 3-4 show different views of the electric machine, depicted in FIG. 2.

FIGS. 5-10 show different examples of serrations in an insert for an electric machine.

FIG. 11 shows another example of a rotor shaft for a cooling system of an electric machine.

FIG. 12 shows another example of a rotor shaft for an electric machine cooling system.

FIG. 13 shows a detailed view of a portion of the rotor shaft depicted in FIG. 12.

FIGS. 14-15 show different views of an insert in the rotor shaft depicted in FIG. 12.

FIGS. 16-17 show different views of an electric machine cooling system in which the rotor shaft depicted in FIG. 12 is incorporated.

### DETAILED DESCRIPTION

A cooling system for an electric machine is described herein which achieves increased performance (e.g., enhanced thermal management) and decreased weight in a robust and efficiently manufacturable package when compared to previous motor cooling systems. To achieve these characteristics, the cooling system includes, in one example, an insert for a rotor shaft where oil is sprayed into a tapered section of the rotor shaft. The oil forms a film which travels down the insert which may be constructed out of aluminum or other suitable material. To induce oil flow of the film, the insert may include serrations to drive the oil flow.

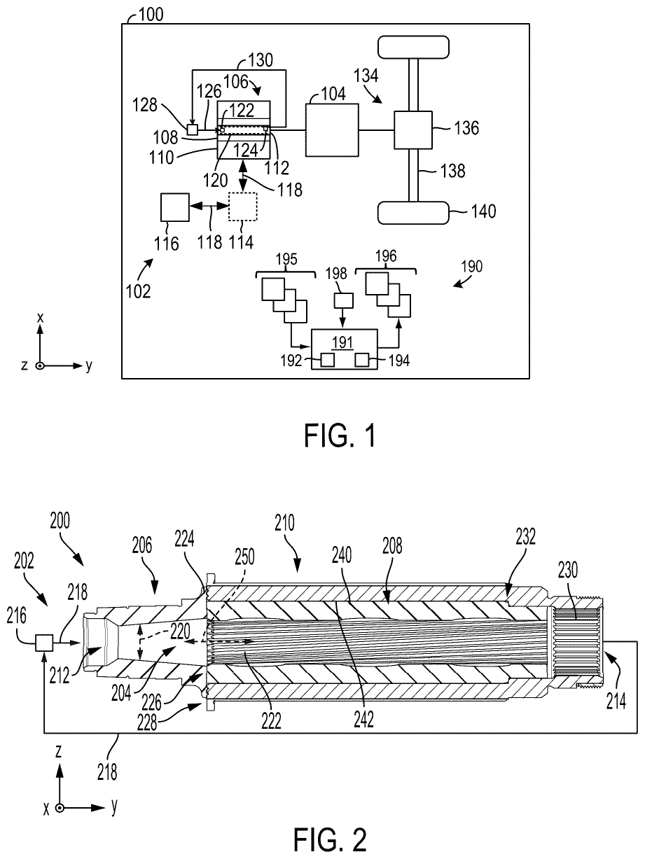

FIG. 1 shows a schematic illustration of a vehicle 100. The vehicle may be a passenger vehicle, a commercial vehicle, an on-highway vehicle, or an off-highway vehicle, in different examples.

In the vehicle example, the vehicle 100 includes a powertrain 102 with a transmission 104 (e.g., gearbox) and an electric machine 106. In such an example, the electric machine 106 may be a traction motor. However, in alternate examples, the electric machine 106 may be included in other suitable systems such as industrial machines, agricultural systems, mining systems, and the like.

When the electric machine 106 is a traction motor, the motor may be included in an electric drive system. In the electric drive example, power may flow from the transmission to the electric motor while the motor is operated as a generator, during certain conditions.

In the electric vehicle (EV) example, the EV may be an all-electric vehicle (e.g., a battery electric vehicle (BEV)), in one example, or a hybrid electric vehicle (HEV) with an internal combustion engine, in another example.

The electric machine 106 includes a rotor 108 that electromagnetically interacts with a stator 110 to drive rotation of a rotor shaft 112 that is included in the rotor. The electric machine 106 may further include a housing, bearings coupled to the rotor shaft, and the like.

More generally, the electric machine 106 may be a multi-phase alternating current (AC) machine. However, in other examples, the electric machine 106 may be a direct current (DC) machine. In the AC machine example, the electric machine 106 may be electrically coupled to an inverter 114. The inverter 114 is designed to convert DC power to AC power and vice versa. However, in other examples, the electric machine 106 may be a DC electric motor (as previously indicated) and the inverter 114 may therefore be omitted from the vehicle 100. The inverter 114 may receive electric energy from one or more energy storage device(s) 116 (e.g., traction batteries, capacitors, combinations thereof, and the like). Arrows 118 signify the electric energy transfer between the electric machine 106, the inverter 114, and the energy storage device(s) 116 that may occur during different modes of system operation.

The electric machine 106 includes a cooling system 120 (e.g., a traction motor cooling system) incorporated into the rotor shaft 112. The cooling system 120 is schematically depicted in FIG. 1. However, the cooling system has greater complexity that is expanded upon herein with regard to FIG. 2.

The cooling system 120 includes an oil inlet 122 and an oil outlet 124. Arrow 126 denotes the general flow of oil from an oil source 128 to the oil inlet 122 in the cooling system 120 and arrow 130 denotes the general flow of oil from the oil outlet 124 in the cooling system. To elaborate, oil may be sprayed into the oil inlet 122 via a nozzle and/or other suitable device in the cooling system. The oil source 128 may include components such as an oil reservoir (e.g., a sump), a pump, a filter, and/or a heat exchanger.

Further, the transmission 104 is mechanically coupled to an axle assembly 134 to enable torque transfer therebetween. The axle assembly 134 may include a differential 136, axle shafts 138, and/or drive wheels 140, in the illustrated example.

The vehicle 100 may further include a control system 190 with a controller 191 (e.g., a vehicle control unit (VCU)), as shown in FIG. 1. The controller 191 may include a microcomputer with components such as a processor 192 (e.g., a microprocessor unit), input/output ports, an electronic storage medium 194 for executable programs and calibration values (e.g., a read-only memory chip, random access memory, keep alive memory, a data bus, and the like). The storage medium may be programmed with computer readable data representing instructions that are executable by the processor for performing the methods and control techniques described herein as well as other variants that are anticipated but not specifically listed. As such, the control techniques, methods, and the like expanded upon herein may be stored as instructions in non-transitory memory.

The controller 191 may receive various signals from sensors 195 coupled to various regions of the vehicle 100. For example, the sensors 195 may include a pedal position sensor designed to detect a depression of an operator-actuated pedal such as an accelerator pedal and/or a brake pedal, speed sensor(s) at the transmission input and/or output shaft, a motor speed sensor, and the like. An input device 198 (e.g., accelerator pedal, brake pedal, drive mode selector, gear selector, combinations thereof, and the like) may further provide input signals indicative of an operator's intent for system control.

Upon receiving the signals from the various sensors 195 of FIG. 1, the controller 191 processes the received signals, and employs various actuators 196 of system components to adjust the components based on the received signals and instructions stored on the memory of controller 191. For example, the controller 191 may adjust the speed of the electric machine 106 via adjustment of the inverter 114, for instance. For instance, the controller 191 may determine that electric machine's speed should be adjusted and responsive to such a determination the controller may send a command to the inverter to adjust electric machine speed. The other controllable components in the system may function in a similar manner with regard to sensor signals, control commands, and actuator adjustment, for example.

An axis system is provided in FIG. 1 as well as FIGS. 2-17, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

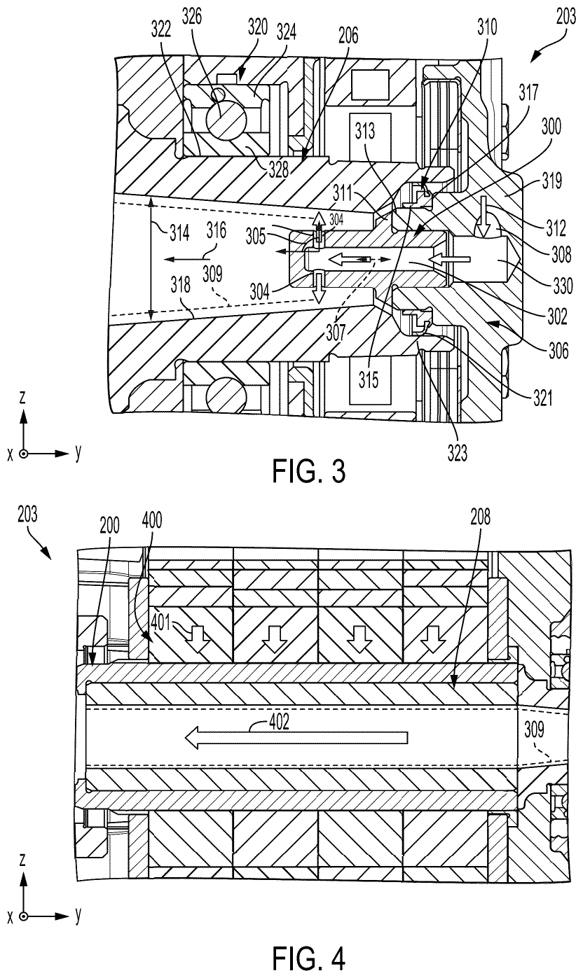

FIG. 2 shows an example of a rotor shaft 200 with a cooling system 202. The rotor shaft 200 is included in an electric machine 203 shown in FIGS. 3-4 and discussed in greater detail herein. Further, it will be understood that the rotor shaft 200 and the cooling system 202 may be included in the electric machine 106, shown in FIG. 1, in one example. However, the rotor shaft 200 and the cooling system 202 may be included in another suitable electric machine, in alternate examples. The rotor shaft 200 is depicted in FIG. 2 in cross-section. The cutting plane for the cross-sectional view depicted in FIG. 2 extends through a rotational axis 250 of the rotor shaft. The other cross-sectional views depicted herein also have a similar cutting plane.

The rotor shaft 200 includes a central cavity 204 through which oil travels during motor operation. The rotor shaft 200 is formed via different sections, in the illustrated example. To elaborate, the rotor shaft 200 includes a tapered section 206, an insert 208, and an outer section 210.

The tapered section 206 includes an inlet 212 and the outer section 210 includes an outlet 214. The inlet 212 is positioned at a first axial end of the rotor shaft 200 and the outlet 214 is positioned at a second axial end of the rotor shaft 200. The inlet 212 and the outlet 214 are in fluidic communication with an oil source 216 as denoted via arrows 218. The oil source may include a pump, an oil reservoir, a filter, combinations thereof, and the like.

The oil source 216 may be configured to spray oil into the inlet 212. As such, the oil source may include a nozzle and/or other suitable component(s) for spraying oil into the rotor shaft's internal cavity.

The tapered section 206 includes an inner diameter 220 that decreases in an axial direction that extends toward the inlet 212. Tapering the rotor section in this manner allows the oil droplets to be increased in speed and pushed in an axial direction that extends towards the outlet 214.

In the illustrated example, the insert 208 is circumferentially enclosed via the outer section 210. However, other insert profiles are possible. An outer surface 240 of the insert 208 may be mechanically bonded to an inner surface 242 of the outer section 210. Bonding these surfaces will result in a decrease of thermal resistance between the components, which results in increased cooling performance. Mechanical bonding between the insert 208 and the outer section 210 may be achieved with a thermally conductive adhesive, brazing (e.g., a complete brazing) of both surfaces, radially pushing the outer section inwards when the insert is inside, using suitable press-fit methods (e.g., ISO and/or ANSI press-fit techniques), combinations thereof, and the like.

As shown in FIG. 2, the insert 208 does not include an internally closed oil channel. The insert 208 may include multiple grooves 222 (e.g., serrations) at an inner diameter. To expound, the grooves 222 may be arranged in a spiral pattern, in one example. In another example, the grooves may be arranged in a straight pattern. In other words, the grooves and grooves may have a zero helix angle or a non-zero helix angle.

Using grooves allows the heat transfer from the rotor shaft to the oil to be increased, thereby increasing the system's cooling performance. Further, the grooves allow the insert to effectively direct oil in an axial direction towards the outlet 214.

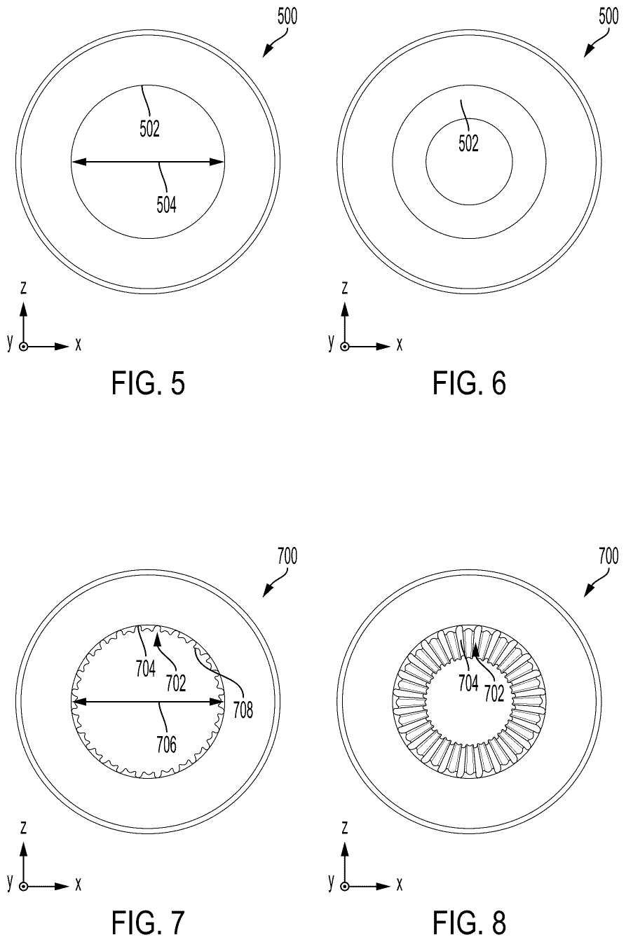

Examples of different inserts are shown in FIGS. 5-10. The inserts shown in FIGS. 5-10 may be used in the rotor shaft 200 shown in FIGS. 2-4. Further, FIGS. 5, 7, and 9 depict cross-sectional views of different inserts. FIGS. 6, 8, and 10 depict the inserts with the interior surfaces drawn in perspective to reveal the contours of the surfaces.

FIGS. 5-6 show a first example of an insert 500. The insert 500 includes an inner surface 502 that does not include any grooves and serrations, in the illustrated example. The inner diameter 504 of the insert may be constant along its length.

FIGS. 7-8 show a second example of an insert 700. An inner surface 702 of the insert 700 includes grooves 704. The grooves 704 have a straight profile along the central axis of the insert. Again the inner diameter 706 of the insert may be constant along its length. Further, the grooves 704 may have a curved inner contour 708.

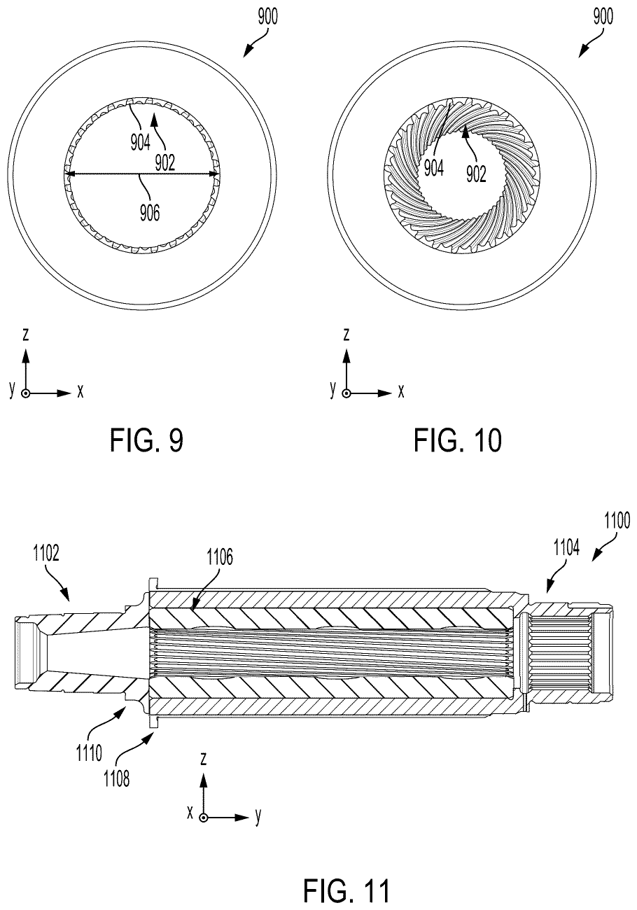

FIGS. 9-10 show a third example of an insert 900. An inner surface 902 of the insert 900 includes grooves 904. The grooves 904 have a spiral profile along the central axis of the insert. Again the inner diameter 906 of the insert may be constant along its length.

Returning to FIG. 2, the tapered section 206 and the outer section 210 may be constructed out of a different metal than the insert 208. To elaborate, the tapered section 206 and the outer section 210 may be constructed out of steel, in one example. Further, in such an example, the insert 208 may be constructed out of aluminum. Aluminum has greater thermal conductivity and is lighter than steel. As such, the rotor shaft's weight may be decreased and the shaft's heat transfer capabilities may be increased when an aluminum insert it used in the cooling system.

In the illustrated example, the tapered section 206 includes a flange 224. However, in an alternate example, the flange may be omitted from the tapered section. To elaborate, the flange 224 is in face sharing contact with an axial end 226 of the insert 208 and an axial end 228 of the outer section 210, in the illustrated example. The flange 224 may be welded and/or otherwise coupled to the axial ends of the insert and the outer section of the rotor shaft. However, the tapered section may have other suitable contours in other examples.

The outer section 210 may include an interior splined section 230 which may allow the shaft to be attached to downstream components such as a gearbox shaft, for instance. However, other suitable rotor shaft attachment interfaces may be used in other examples.

A stepped interface 232 may be formed between the outer section 210 and the insert 208 which allows the insert to be placed in a desired positon during insert installation. However, other contours of the rotor shaft have been contemplated.

Designing the rotor shaft with the tapered section 206, the insert 208, and the outer section 210 allows the shaft to be more efficiently manufactured, if so desired. Further, internally closed oil channels may be omitted from the rotor shaft, in one specific example, thereby decreasing cooling losses from air entrapment. Further, the oil in the interior of the rotor shaft 200 may stay within a film thickness when traveling through the shaft, thereby decreasing losses in the oil flow through the rotor shaft. A rotational axis 250 of the rotor shaft 200 is provided for reference in FIG. 2. The insert 208 does not include a closed oil channel in the illustrated example. To elaborate, a film of oil forms on the inner diameter of the insert during cooling system operation and air is able to flow through the insert, radially inward from the oil film. In this way, the cooling system achieves increased cooling when compared to other rotor cooling systems.

FIG. 3 shows a cross-sectional view of the electric machine 203. The tapered section 206 of the rotor shaft 200 is again illustrated. A tube inlet 300 may be positioned within the tapered section 206. The tube inlet 300 may include an oil channel 302 that delivers oil to nozzles 304 (e.g., radial nozzles). The nozzles 304 in turn deliver oil to the tapered section 206. To elaborate, the nozzles 304 spray oil towards the walls of the tapered section 206. It will be appreciated that the oil within the tapered section and the insert may not be pressurized.

The angles 305 between the central axis of the nozzles 304 and the central axis 307 of the tube inlet 300 is depicted in FIG. 3. The angle 305 is 90°, in the illustrated example. However, other suitable nozzle angles may be used in other examples.

A film thickness 309 of the oil occurs due to the high-speed rotation of the rotor during machine operation in a non-pressurized environment. A back cover 306 may include an oil conduit 308 that delivers oil to the tube inlet 300 via an oil conduit outlet 330. A seal 310 may be positioned between the tube inlet 300 and the back cover 306 to reduce the chance of oil leaking into undesirable portions of the machine. In other words, the seal 310 assists in retaining the oil inside the rotor shaft.

The tube inlet 300 includes a flange 311 that is in contact with a section 313 of a housing 319. The seal 310 is arranged axially outboard from the interface between the flange 311 and the housing section 313, in the illustrated example. The seal 310 may specifically include surfaces 315 and 317 in contact with stepped surfaces in the housing 319. The seal 310 may further include a section 321 that is in sealing contact with an extension 323 of the tapered section 206. In this way, the seal functions to contain oil within the rotor shaft. Further, the tube inlet 300 is circumferentially enclosed by the extension 323, in the illustrated example.

Arrows 312 denote the general flow of oil through the back cover 306, the tube inlet 300, and the nozzles 304. However, it will be understood that the oil flow pattern may have greater complexity. After the oil forms the film thickness 309 on the wall of the tapered section the oil travel axially towards the insert and then through the insert.

The inner diameter 314 of the tapered section 206 increases in axial direction 316, in the illustrated example, to allow the oil to be effectively distributed along the inner surface 318 for increased rotor shaft cooling.

A bearing 320 may be coupled to an outer surface 322 of the tapered section 206. The bearing 320 includes an outer race 324, roller elements 326, and an inner race 328, in the illustrated example.

FIG. 4 shows another cross-sectional view of the electric machine 203. A rotor core 400 in the electric machine is depicted. The rotor core 400 is coupled to the rotor shaft 200. Arrows 401 denotes the transfer of heat from the rotor core 400 to the rotor shaft 200. The oil flows from small diameter sections to big diameter sections in a high-speed rotation environment.

The film thickness 309 is again illustrated. However, as depicted the film thickness 309 extends into the insert 208. The majority of the heat transfer to the oil may occur at the film thickness. Arrow 402 denotes the general direction of oil flow through the insert 208.

FIG. 11 shows another example of a rotor shaft 1100. The rotor shaft 1100 is depicted in FIG. 11 in cross-section. The rotor shaft 1100 again includes a tapered section 1102, an outer section 1104, and an insert 1106. It will be understood, that the rotor shaft 1100 may be used in any of the electric machine cooling systems or combinations of the cooling systems described herein. The insert 1106 includes a flange 1108 that is in face sharing contact with a flange 1110 of the tapered section 1102.

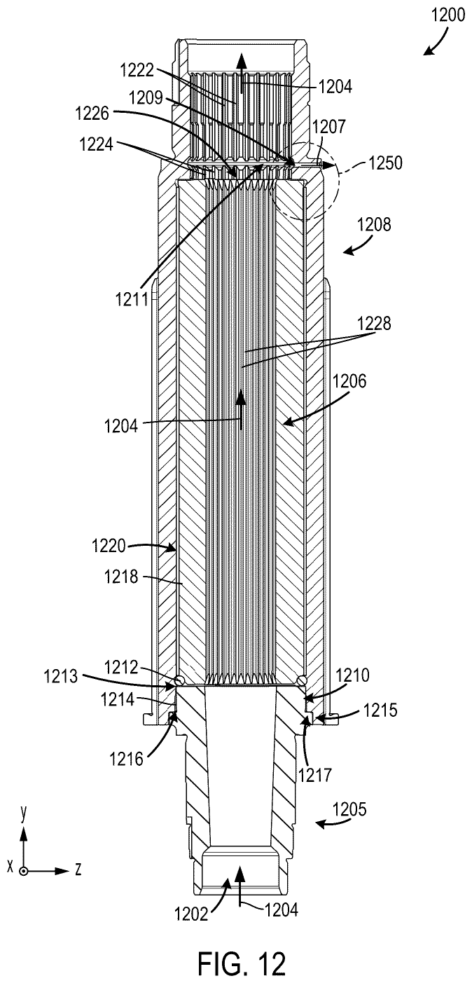

FIG. 12 shows another example of a rotor shaft 1200 that may be included in any of the electric machine cooling systems or combinations of the cooling systems described herein. The rotor shaft 1200 is depicted in FIG. 12 in cross-section. The rotor shaft 1200 again includes a central cavity 1202 through which oil travels during electric machine operation. Arrows 1204 indicate the general direction of oil flow through the central cavity. Arrow 1207 denotes the direction of oil flow through a lubrication channel 1209 that is discussed in greater detail herein. An oil collector 1211 for the lubrication channel 1209 may be formed in an outer section 1208.

The rotor shaft 1200 is formed via different sections, in the illustrated example. To elaborate, the rotor shaft 1200 includes a tapered section 1205, an insert 1206, and the outer section 1208. Again the tapered section 1205 and the outer section 1208 may be constructed out of steel and the insert may be constructed out of aluminum.

A section 1210 of the tapered section 1205 is mated with a portion of the outer section 1208, in the illustrated example. An O-ring 1212 may be positioned at the interface 1213 between the insert 1206, the tapered section 1205, and the outer section 1208.

A weld 1214 (e.g., a laser weld) may be formed at an interface 1216 between the tapered section 1205 and the outer section 1208. The tapered section 1205 may include a stepped section 1215 that mates with a recess 1217 in the outer section 1208.

Thermal grease 1218 may be provided at the interface 1220 that is formed between the outer section 1208 and the insert 1206. The O-ring 1212 reduces the chance of grease contamination when welding the tapered section to the outer section.

The outer section 1208 again includes a set of output shaft splines 1222 that are profiled to mate with an output shaft. The outer section 1208 further includes another set of splines 1224. The splines 1224 are profiled to rotationally lock the insert 1206 in place when inserted into the outer section 1208. To elaborate, an end 1226 of the insert 1206 is deformed by the splines 1224 when the insert is mated with the outer section.

The insert 1206 includes multiple grooves and serrations 1228 at an inner diameter. The grooves and serrations 1228 have a straight contour where the grooves extend in axial directions along the inner diameter of the insert.

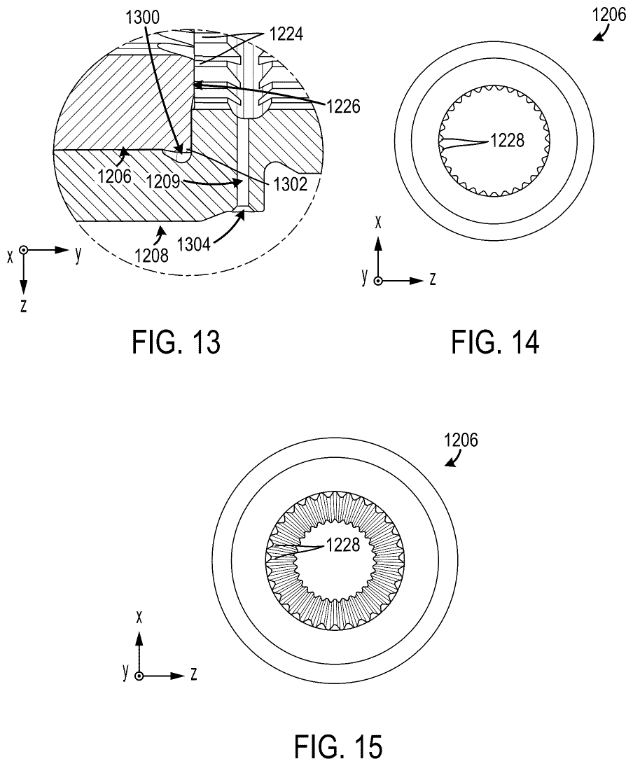

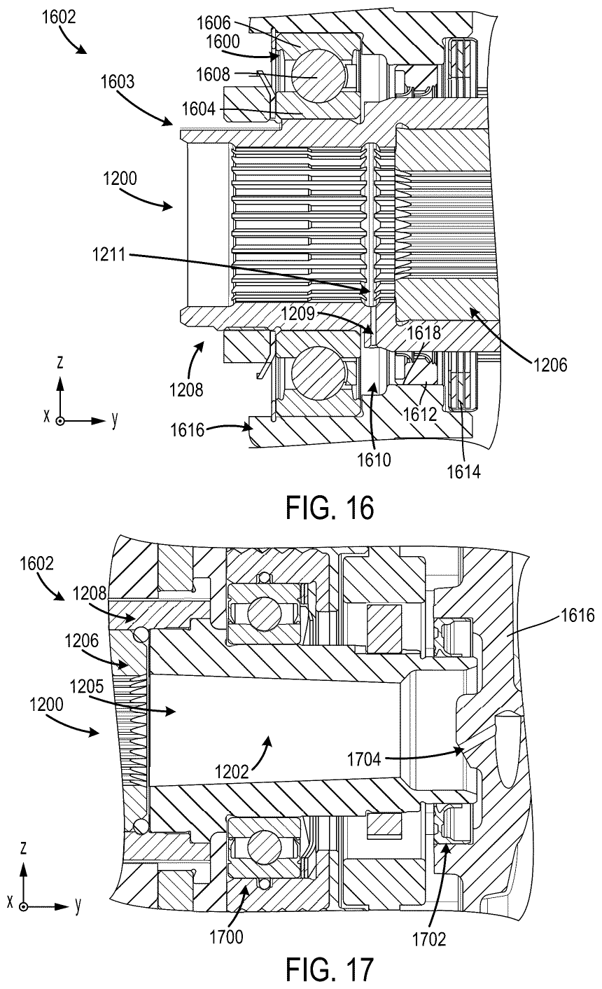

The lubrication channel 1209 is formed in the outer section 1208 downstream of the interface between the outer section and the insert 1206, in the illustrated example. The lubrication channel 1209 delivers oil to a rotor shaft bearing 1600, shown in FIG. 16 and discussed in greater detail herein. A boundary 1250 of the detailed view depicted in FIG. 13 is provided in FIG. 11 for reference.

FIG. 13 shows a detailed view of a portion of the rotor shaft 1200 and specifically the portion of the outer section 1208 that includes the lubrication channel 1209. The outer section 1208 includes an undercut 1300 in the illustrated example. The undercut 1300 allows a section 1302 of the insert 1206 to deform to axial lock the insert 1206 with regard to the outer section 1208. As previously discussed, the end 1226 of the insert 1206 deforms when inserted into the splines 1224 such that the insert 1206 is rotationally locked with regard to the outer section 1208. An outlet 1304 of the lubrication channel 1209 is further illustrated in FIG. 13.

FIGS. 14-15 show front and rear views of the insert 1206, respectively. The grooves and serrations 1228 at the inner diameter of the insert 1206 are again shown in FIGS. 14-15. The grooves and serrations are axially aligned in the illustrated example. However, the grooves and serrations may have other profiles, as discussed above.

FIG. 16 shows a cross-sectional view of the rotor shaft 1200 incorporated into an electric machine 1602. Specifically, FIG. 16 shows a drive side 1603 of the electric machine 1602. The bearing 1600 is coupled to an outer circumference of the outer section 1208. The bearing 1600 is a ball bearing with an inner race 1604, an outer race 1606, and balls 1608 that are arranged between the races. The lubrication channel 1209 opens into a region 1610 that is located axially inboard from the bearing 1600. The oil collector 1211 that supplies oil to the lubrication channel 1209, is again illustrated in FIG. 16. In this way, a desired oil flow to the bearing 1600 can be achieved.

A rotary seal 1612 is coupled to the outer section 1208 at a location inboard from the bearing and the region 1610. A grounding ring 1614 is coupled to the outer section 1208 at a location axial inboard from the rotary seal 1612, in the illustrated example.

A housing 1616 encloses the bearing 1600, the rotary seal 1612, and the grounding ring 1614. To elaborate, sections of the bearing 1600, the rotary seal 1612, and the grounding ring 1614 are in face sharing contact with an inner surface 1618 of the housing 1616.

FIG. 17 shows another cross-sectional view of another portion of the electric machine 1602. The tapered section 1205, the insert 1206, and the outer section 1208 of the rotor shaft 1200 are again illustrated. A bearing 1700 is coupled to an outer circumference of the tapered section 1205. The bearing 1700 is a ball bearing, in the illustrated example. A rotary seal 1702 is coupled to the insert 1206, in the illustrated example. Further, an oil nozzle 1704 is embedded in the housing 1616, in the illustrated example. As such, the oil entering the central cavity 1202 of the rotor shaft 1200 flows from the oil nozzle 1704 into the central cavity. A pump drives the oil flow through the rotor cooling system, as previously discussed.

The descriptions of FIGS. 1-17 provide for a method in which a rotor shaft of an electric machine is rotated based on system operating conditions. For instance, a controller may send a command to an inverter to induce rotor rotation or increase machine speed. In response, the inverter may transfer AC to the electric machine to cause electric machine rotation. The technical effect of the methods described herein is to effectively cool a rotor shaft of an electric machine to increase machine efficiency and longevity.

FIGS. 2-17 are drawn approximately to scale, aside from the schematically depicted components. However, other relative component dimensions may be used in alternate examples. FIGS. 1-17 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such. Still further, an axis about which a component rotates may be referred to as a rotational axis. Components fixedly coupled to one another may be referred to as such.

The invention will be further described in the following paragraphs. In one aspect, an electric machine is provided that comprises a rotor shaft including a central cavity; an oil inlet; a tapered section profiled to direct oil away from the oil inlet and toward an oil outlet; and an insert positioned within an outer rotor shaft section and configured to direct oil towards the oil outlet. In one example, the outer rotor shaft section and the insert may be constructed out of different metals. Further, in one example, the insert may be constructed out of aluminum. In another example, the rotor shaft may be constructed out of steel. Further, in one example, an axial end of the insert may abut an axial end of the tapered section. Further, in one example, the insert may include a plurality of serrations. Further, in one example, the insert may have groove between the plurality of serrations with a spiral or straight shape. Still further, in one example, an inner diameter of the tapered section of the rotor shaft may decrease in an axial direction that extends towards the oil inlet. Further in one example, the electric machine may be a traction motor in an electric drive system. In one example, the electric machine cooling system may further comprise a first rotary seal coupled to the outer section at a drive side of the rotor shaft; and a second rotary seal coupled to the tapered section. In another example, the insert may include a plurality of serrations and grooves; and the plurality of serrations and groove may have a spiral shape or a straight shape. Further, in one example, the outer rotor shaft section may include a set of splines that rotationally lock the insert in relation the outer rotor shaft section.

In another aspect, a method for operation of an electric machine is provided that comprises rotating a rotor shaft; wherein rotation of the rotor shaft induces oil flow from an oil inlet to a tapered section of the rotor shaft, from the tapered section of the rotor shaft to an insert which is positioned in a central cavity of the rotor shaft, and from the insert to an oil output; and wherein the rotor shaft and the insert are constructed out of different metals. In one example, the insert may include a plurality of serrations which have a spiral shape or a straight shape. Still further, in one example, the insert may be constructed out of aluminum and the rotor shaft may be constructed out of steel.

In another aspect, a traction motor is provided that comprises a rotor shaft including: a central cavity; a tapered section with an oil inlet and an inner diameter that decreases in an axial direction which extends towards the oil inlet; and an insert positioned in an outer rotor shaft section and including a plurality of serration formed in a pattern that direct oil towards an oil outlet; wherein the outer rotor shaft section and the insert are constructed out of different metals. In one example, the rotor shaft may be constructed out of steel and the insert is constructed out of aluminum. Further, in one example, the tapered section may include a flange that is in face sharing contact with an axial end of the insert. Further, in one example, the flange may be in face sharing contact with an outer section of the rotor shaft. Further, in one example, an outer surface of the insert may be mechanically bonded to an inner surface of the shaft. Further, in one example the pattern may be a spiral pattern or a straight pattern. In another example, the mechanical bonding may include one or more of welding, adhesively bonding, brazing, and press-fitting. In yet another example, the insert may not include an internally closed oil channel.

Note that the example control and estimation routines included herein can be used with various system (e.g., transmission) configurations. The control methods and routines disclosed herein may be stored as executable instructions in non-transitory memory and may be carried out by the control system including the controller in combination with the various sensors, actuators, and other system hardware in combination with the electronic controller. As such, the described actions, operations, and/or functions may graphically represent code to be programmed into non-transitory memory of the computer readable storage medium in the vehicle and/or powertrain control system.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to a variety of systems. In one specific example, the above technology can be applied to powertrains that include different types of propulsion sources including different types of traction motors, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine cooling system, comprising:
a rotor shaft including:
a central cavity;
an oil inlet;
a tapered section profiled to direct oil away from the oil inlet and toward an oil outlet; and
an insert positioned within an outer rotor shaft section and configured to direct oil towards the oil outlet.

2. The electric machine cooling system of claim 1, wherein the outer rotor shaft section and the insert are constructed out of different metals.

3. The electric machine cooling system of claim 2, wherein the insert is constructed out of aluminum and the outer rotor shaft section is constructed out of steel.

4. The electric machine cooling system of claim 1, further comprising:
a first rotary seal coupled to the outer rotor shaft section at a drive side of the rotor shaft; and
a second rotary seal coupled to the tapered section.

5. The electric machine cooling system of claim 1, wherein an axial end of the insert abuts an axial end of the tapered section.

6. The electric machine cooling system of claim 1, wherein:
the insert includes a plurality of serrations and grooves; and
the plurality of serrations and groove have a spiral shape or a straight shape.

7. The electric machine cooling system of claim 1, wherein the outer rotor shaft section includes a set of splines that rotationally lock the insert in relation to the outer rotor shaft section.

8. The electric machine cooling system of claim 1, wherein an inner diameter of the tapered section of the rotor shaft decreases in an axial direction that extends towards the oil inlet.

9. The electric machine cooling system of claim 1, wherein the electric machine is a traction motor in an electric drive system.

10. A method for operation of an electric machine with a cooling system, comprising:
rotating a rotor shaft;
wherein rotation of the rotor shaft induces oil flow from an oil inlet to a tapered section of the rotor shaft, from the tapered section of the rotor shaft to an insert which is positioned in a central cavity of the rotor shaft, and from the insert to an oil output; and
wherein the rotor shaft and the insert are constructed out of different metals.

11. The method of claim 10, wherein the insert includes a plurality of serrations which have a spiral shape or a straight shape.

12. The method of claim 10, wherein the insert is constructed out of aluminum and the rotor shaft is constructed out of steel.

13. A traction motor cooling system, comprising:
a rotor shaft including:
a central cavity;
a tapered section with an oil inlet and an inner diameter that decreases in an axial direction which extends towards the oil inlet; and
an insert positioned in an outer rotor shaft section and including a plurality of serration formed in a pattern that direct oil towards an oil outlet;
wherein the outer rotor shaft section and the insert are constructed out of different metals.

14. The traction motor cooling system of claim 13, wherein the outer rotor shaft section is constructed out of steel and the insert is constructed out of aluminum.

15. The traction motor cooling system of claim 13, wherein the tapered section includes a flange that is in face sharing contact with an axial end of the insert.

16. The traction motor cooling system of claim 15, wherein the flange is in face sharing contact with an outer section of the rotor shaft.

17. The traction motor cooling system of claim 13, wherein the pattern is a spiral pattern or a straight pattern.

18. The traction motor cooling system of claim 13, wherein an outer surface of the insert is mechanically bonded to an inner surface of the outer rotor shaft section.

19. The traction motor cooling system of claim 18, wherein the mechanical bonding includes one or more of welding, adhesively bonding, brazing, and press-fitting.

20. The traction motor cooling system of claim 13, wherein the insert does not include an internally closed oil channel.
